(19) United States
(12) Patent Application Publication
(10) Pub. No.: US 2022/0169369 A1
(43) Pub. Date: Jun. 2, 2022

(54) LOW-NOISE ROTOR CONFIGURATIONS

(71) Applicant: Bell Textron Inc., Fort Worth, TX (US)

(72) Inventors: Alexander Dang Quang Truong, Dallas, TX (US); Bradley Joseph Passe, Irving, TX (US)

(73) Assignee: Bell Textron Inc., Fort Worth, TX (US)

(21) Appl. No.: 17/106,481

(22) Filed: Nov. 30, 2020

(51) Int. Cl. B64C 27/00

(52) U.S. Cl. CPC B64C 27/001; B64C 2027/003

(57) ABSTRACT

In an embodiment, an aircraft includes a fuselage and a first support boom extending from the fuselage and having a first boom thickness. The aircraft also includes a first propulsion assembly coupled to the first support boom. The first propulsion assembly includes a first rotor hub and first rotor blades extending from the first rotor hub and operable to rotate in a first rotor plane with the first rotor hub. The aircraft also includes a first separation between the first rotor plane and the first support boom of not less than approximately 1.5 times the first boom thickness.

### BACKGROUND

### Technical Field

The present disclosure relates generally to aircraft and more particularly, but not by way of limitation, to low-noise rotor configurations.

### History of Related Art

Unlike fixed-wing aircraft, vertical takeoff and landing (“VTOL”) aircraft do not require runways. Instead, VTOL aircraft can take off, hovering, and landing vertically. One example of VTOL aircraft is a helicopter, which is a rotorcraft having one or more rotors that provide vertical lift and forward thrust to the aircraft. Helicopter rotors not only enable hovering and vertical takeoff and vertical landing, but also enable forward, aftward, and lateral flight. These attributes make helicopters highly versatile for use in congested, isolated or remote areas where fixed-wing aircraft may be unable to take off and land. Helicopters, however, typically lack the forward airspeed of fixed-wing aircraft.

A tiltrotor is another example of a VTOL aircraft. Tiltrotor aircraft utilize tiltable rotor systems that may be transitioned between a forward thrust orientation and a vertical lift orientation. The rotor systems are tiltable relative to one or more fixed wings such that the associated proprotors have a generally horizontal plane of rotation for vertical takeoff, hovering, and vertical landing and a generally vertical plane of rotation for forward flight, or airplane mode, in which the fixed wing or wings provide lift. In this manner, tiltrotor aircraft combine the vertical lift capability of a helicopter with the speed and range of fixed-wing aircraft. Yet another type of VTOL aircraft is commonly referred to as a “tail-sitter.” As the name implies, a tail-sitter takes off and lands on its tail, but tilts horizontally for forward flight.

VTOL aircraft may be manned or unmanned. An unmanned aerial vehicle (“UAV”), also commonly referred to as a “drone,” is an aircraft without a human pilot aboard. UAVs may be used to perform a variety of tasks, including filming, package delivery, surveillance, and other applications. UAVs may also serve as air taxis. A UAV typically forms a part of an unmanned aircraft system (“UAS”) that includes the UAV, a ground-based controller, and a system of communication between the vehicle and controller.

### SUMMARY

In an embodiment, an aircraft includes a fuselage and a first support boom extending from the fuselage. The aircraft also includes a first propulsion assembly coupled to the first support boom. The first propulsion assembly includes a first rotor hub and first rotor blades extending from the first rotor hub and operable to rotate in a first rotor plane with the first rotor hub. The first propulsion assembly also includes a second rotor hub and second rotor blades extending from the second rotor hub and operable to rotate in a second rotor plane with the second rotor hub. The aircraft also includes a first separation between the first rotor plane and the first support boom, the first separation having a first separation distance. The aircraft also includes a second separation between the first support boom and the second rotor plane, the second separation having a second separation distance, where the first separation distance and the second separation distance are unequal.

In an embodiment, an aircraft includes a fuselage and a first support boom extending from the fuselage and having a first boom thickness. The aircraft also includes a first propulsion assembly coupled to the first support boom. The first propulsion assembly includes a first rotor hub and first rotor blades extending from the first rotor hub and operable to rotate in a first rotor plane with the first rotor hub. The aircraft also includes a first separation between the first rotor plane and the first support boom of not less than approximately 1.5 times the first boom thickness.

### BRIEF DESCRIPTION OF THE DRAWINGS

A more complete understanding of the method and apparatus of the present disclosure may be obtained by reference to the following Detailed Description when taken in conjunction with the accompanying Drawings wherein:

FIG. 1 illustrates an aircraft; and

FIG. 2 illustrates a perspective view of a propulsion assembly.

### DETAILED DESCRIPTION

The following disclosure describes various illustrative embodiments and examples for implementing the features and functionality of the present disclosure. While particular components, arrangements, and/or features are described below in connection with various example embodiments, these are merely examples used to simplify the present disclosure and are not intended to be limiting. It will of course be appreciated that in the development of any actual embodiment, numerous implementation-specific decisions may be made to achieve the developer's specific goals, including compliance with system, business, and/or legal constraints, which may vary from one implementation to another. Moreover, it will be appreciated that, while such a development effort might be complex and time-consuming, it would nevertheless be a routine undertaking for those of ordinary skill in the art having the benefit of this disclosure.

While the making and using of various embodiments of the present disclosure are discussed in detail below, it should be appreciated that the present disclosure provides many applicable inventive concepts, which can be embodied in a wide variety of specific contexts. The specific embodiments discussed herein are merely illustrative and do not delimit the scope of the present disclosure. In the interest of clarity, not all features of an actual implementation may be described in the present disclosure.

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom” or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature) of an element, operations, and/or conditions, the phrase “between X and Y” represents a range that includes X and Y.

Further, as referred to herein in this Specification, the terms “forward”, “aft”, “inboard”, and “outboard” may be used to describe relative relationship(s) between components and/or spatial orientation of aspect(s) of a component or components. The term “forward” may refer to a special direction that is closer to a front of an aircraft relative to another component or component aspect(s). The term “aft” may refer to a special direction that is closer to a rear of-an aircraft relative to another component or component aspect(s). The term “inboard” may refer to a location of a component that is within the fuselage of an aircraft and/or a spatial direction that is closer to or along a centerline of the aircraft relative to another component or component aspect(s), wherein the centerline runs in a between the front and the rear of the aircraft. The term “outboard” may refer to a location of a component that is outside the fuselage-of an aircraft and/or a special direction that farther from the centerline of the aircraft relative to another component or component aspect(s).

Still further, the present disclosure may repeat reference numerals and/or letters in the various examples. This repetition is for the purpose of simplicity and clarity and does not in itself dictate a relationship between the various embodiments and/or configurations discussed. Example embodiments that may be used to implement the features and functionality of this disclosure will now be described with more particular reference to the accompanying FIGURES.

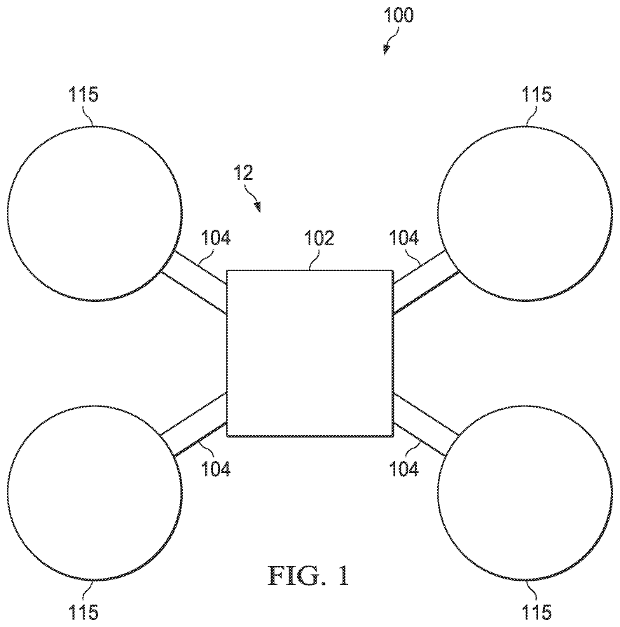

FIG. 1 illustrates a top plan view of an aircraft 100. In some embodiments, aircraft 100 is configured as a vertical takeoff and landing (“VTOL”) aircraft. In some embodiments, aircraft 100 is a drone-type aircraft, for example, configured for remote control and operation. Additionally, at least in some embodiments, aircraft 100 may be fully autonomous and self-directed via a predetermined or preprogrammed location-based guidance system (e.g., global positioning system (“GPS”), coordinate-based location, street address, etc.).

Aircraft 100 includes an airframe 12 having a fuselage 102 and support booms 104 coupled to and extending outboard of fuselage 102. Propulsion assemblies 115 are disposed proximate the outboard end of each support boom 104. Each propulsion assembly 115 comprises one or more selectively rotatable rotor systems. In some embodiments, propulsion assemblies 115 each include a single rotor system including a rotor hub and a plurality of rotor blades. For each such single rotor system, the rotor blades therein are operable to rotate in a rotor plane with the respective rotor hub. Alternatively, in some embodiments, propulsion assemblies 115 each comprise two rotor systems arranged in a coaxial configuration.

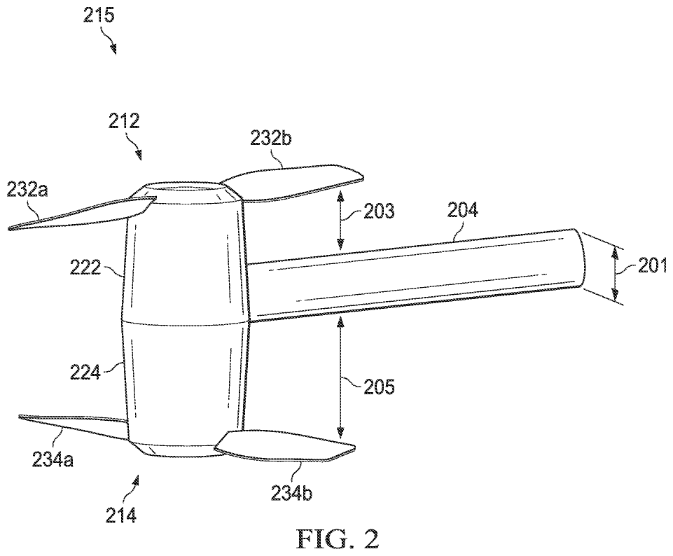

FIG. 2 illustrates a perspective view of a propulsion assembly 215 in a coaxial rotor configuration. Propulsion assembly 215 is coupled to a support boom 204. In an embodiment, propulsion assemblies 115 of aircraft 100 can each be configured in similar fashion to the propulsion assembly 215, with the support boom 204 corresponding to one of the support booms 104 of the aircraft 100 of FIG. 1.

Propulsion assembly 215 includes an upper rotor system 212 and a lower rotor system 214 arranged in a coaxial configuration. In various embodiments, upper rotor system 212 and lower rotor system 214 are selectively rotatable. In an embodiment, upper rotor system 212 and lower rotor system 214 counterrotate. In an embodiment, upper rotor system 212 and lower rotor system 214 co-rotate.

Upper rotor system 212 includes a rotor hub 222 having rotor blades 232a and 232b coupled thereto. In the embodiment shown, upper rotor system 212 is driven by an associated electric motor in rotor hub 222. However, in other embodiments, upper rotor system 212 may be driven by a combustion engine or auxiliary power unit through a plurality of interconnect driveshafts and/or auxiliary gearboxes, which components may likewise reside at least in part in rotor hub 222. Rotor blades 232a and 232b are operable to rotate in a first rotor plane with rotor hub 222. Although two blades are shown for illustrative purposes, it should be appreciated that upper rotor system 212 can include three, four, or any other number of blades that may be suitable for a given implementation.

Lower rotor system 214 includes a rotor hub 224 having rotor blades 234a and 234b coupled thereto. In the embodiment shown, lower rotor system 214 is driven by an associated electric motor in rotor hub 224. However, in other embodiments, lower rotor system 214 may be driven by a combustion engine or auxiliary power unit through a plurality of interconnect driveshafts and/or auxiliary gearboxes, which components may likewise reside at least in part in rotor hub 224. Rotor blades 234a and 234b are operable to rotate in a second rotor plane with rotor hub 224, where the second rotor plane is shown to be substantially parallel to the first rotor plane described above. Although two blades are shown for illustrative purposes, it should be appreciated that lower rotor system 214 can include three, four, or any other number of blades that may be suitable for a given implementation.

For vehicles such as aircraft 100, noise is often a significant concern since such aircraft frequently operate near communities. A problem associated with rotor configurations in such vehicles is propulsion airframe aeroacoustic effects (FAA). When rotor systems operate in close proximity to airframe surfaces such as support booms 104, it can result in generation of considerable tonal acoustic content in the form of harmonics of the rotor blade passage frequency (BPF). With reference to FIG. 2, the presence of support boom 204 under upper rotor system 212, for example, obstructs the downwash, thus causing the flow to turn spanwise along support boom 204. Support boom 204 also acts as a partial ground plane, thus causing a decrease in inflow velocity seen by rotor systems in proximity thereto.

In various embodiments, noise generated by propulsion assembly 215 can be reduced by configuring a first separation 203, or minimum separation, between upper rotor system 212 and support boom 204. For reduced noise, first separation 203 can be established as a function of a thickness 201, or maximum thickness, of support boom 204. First separation 203 may be, for example, a closest separation between support boom 204 and the rotor plane of the upper rotor system 212. In various embodiments, a ratio of first separation 203 to the thickness 201 of less than 1.5 will operate in the exponential region of the noise curve where small changes in separation can result in large increases in noise. Conversely, in various embodiments, such a ratio of greater than 2.7 may not provide significant additional noise reduction and will require additional structure weight. In an embodiment, first separation 203 is defined by a separation distance of not less than approximately 1.5 times the thickness 201. In another embodiment, first separation 203 is defined by a separation distance of approximately 1.5 times the thickness 201. In another embodiment, first separation 203 is defined by a separation distance of approximately 1.5 to 2.7 times the thickness 201. In another embodiment, first separation 203 is defined by a separation distance of approximately 2.7 times the thickness 201. In another embodiment, first separation 203 is defined by a separation distance of approximately 2.0 times the thickness 201. Although the propulsion assembly 215 is shown in a coaxial configuration for illustrative purposes, it should be appreciated that the foregoing principles are also applicable to single-rotor configurations.

In coaxial configurations, such as the one shown relative to propulsion assembly 215, noise can be further reduced by configuring a second separation 205, or minimum separation, between lower rotor system 214 and support boom 204 using the same principles described above relative to first separation 203. Second separation 205 may be, for example, a closest separation between support boom 204 and the rotor plane of the lower rotor system 214. For example, second separation 205 may be defined by a separation distance according to any of the examples described above relative to first separation 203. In the illustrated embodiment, support boom 204 is shown coupled to propulsion assembly 215 at a point between rotor hub 222 and rotor hub 224.

In some embodiments, second separation 205 can be different from first separation 203 in order to compensate for acoustic differences between upper rotor system 212 and lower rotor system 214. In the example of FIG. 2, lower rotor system 214 is downstream of both upper rotor system 212 and support boom 204. Due to the disturbance of inflow from support boom 204, for example, lower rotor system 214 can be much louder than upper rotor system 212. In various embodiments, second separation 205 can be selected to consider the greater noise of lower rotor system 214. In various embodiments, second separation 205 is defined by a separation distance that is incrementally greater than the separation distance of first separation 203. In an example, if first separation 203 is defined by a separation distance of 1.5 times the thickness 201, second separation 205 can be defined by a separation distance that is 2.0 times the thickness 201. Other examples will be apparent to one skilled in the art after a detailed review of the present disclosure.

Although this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. An aircraft comprising:
a fuselage;
a first support boom extending from the fuselage;
a first propulsion assembly coupled to the first support boom, the first propulsion assembly comprising:
a first rotor hub;
first rotor blades extending from the first rotor hub and operable to rotate in a first rotor plane with the first rotor hub;
a second rotor hub;
second rotor blades extending from the second rotor hub and operable to rotate in a second rotor plane with the second rotor hub;
a first separation between the first rotor plane and the first support boom, the first separation having a first separation distance; and
a second separation between the first support boom and the second rotor plane, the second separation having a second separation distance, wherein the first separation distance and the second separation distance are unequal.

2. The aircraft of claim 1, wherein the second separation distance is greater than the first separation distance.

3. The aircraft of claim 1, wherein the first separation distance is not less than approximately 1.5 times a thickness of the first support boom.

4. The aircraft of claim 1, wherein the first separation distance is approximately 1.5 times a thickness of the first support boom.

5. The aircraft of claim 1, wherein the first separation distance is approximately 1.5 to 2.7 times a thickness of the first support boom.

6. The aircraft of claim 5, wherein the second separation distance is greater than the first separation distance.

7. The aircraft of claim 1, wherein the first separation distance is approximately 2 times a thickness of the first support boom.

8. The aircraft of claim 1, wherein the first separation distance is approximately 2.7 times a thickness of the first support boom.

9. The aircraft of claim 1, wherein the first rotor plane is substantially parallel to the second rotor plane.

10. The aircraft of claim 1, wherein the first support boom is coupled to the first propulsion assembly at a point between the first rotor hub and the second rotor hub.

11. The aircraft of claim 1, comprising:
a second support boom extending from the fuselage;
a second propulsion assembly coupled to the second support boom;
a third support boom extending from the fuselage;
a third propulsion assembly coupled to the third support boom;
a fourth support boom extending from the fuselage; and
a fourth propulsion assembly coupled to the fourth support boom.

12. The aircraft of claim 1, wherein the first rotor blades and the second rotor blades are operable to counterrotate.

13. The aircraft of claim 1, wherein the first rotor blades and the second rotor blades are operable to co-rotate.

14. An aircraft comprising:
a fuselage;
a first support boom extending from the fuselage and having a first boom thickness;
a first propulsion assembly coupled to the first support boom, the first propulsion assembly comprising:
a first rotor hub; and
first rotor blades extending from the first rotor hub and operable to rotate in a first rotor plane with the first rotor hub; and
a first separation between the first rotor plane and the first support boom of not less than approximately 1.5 times the first boom thickness.

15. The aircraft of claim 14, wherein the first separation is approximately 1.5 times a thickness of the first support boom.

16. The aircraft of claim 14, wherein the first separation is approximately 1.5 to 2.7 times a thickness of the first support boom.

17. The aircraft of claim 14, wherein the first separation is approximately 2 times a thickness of the first support boom.

18. The aircraft of claim 14, wherein the first separation is approximately 2.7 times a thickness of the first support boom.

19. The aircraft of claim 14, comprising:
a second support boom extending from the fuselage and having a second boom thickness;
a second propulsion assembly coupled to the second support boom, the second propulsion assembly comprising:
a second rotor hub; and
second rotor blades extending from the second rotor hub and operable to rotate in a second rotor plane with the second rotor hub; and
a second separation between the second rotor plane and the second support boom of not less than approximately 1.5 times the second boom thickness.

20. The aircraft of claim 19, comprising:
a third support boom extending from the fuselage and having a third boom thickness;
a fourth support boom extending from the fuselage and having a fourth boom thickness;
a third propulsion assembly coupled to the third support boom, the third propulsion assembly comprising:
a third rotor hub; and
third rotor blades extending from the third rotor hub and operable to rotate in a third rotor plane with the third rotor hub; and
a fourth propulsion assembly coupled to the fourth support boom, the fourth propulsion assembly comprising:
a fourth rotor hub; and
fourth rotor blades extending from the fourth rotor hub and operable to rotate in a fourth rotor plane with the fourth rotor hub;
a third separation between the third rotor plane and the thiol support boom of not less than approximately 1.5 times the third boom thickness; and
a fourth separation between the fourth rotor plane and the fourth support boom of not less than approximately 1.5 times the fourth boom thickness.
